(19) United States
(12) Patent Application Publication
(10) Pub. No.: US 2004/0252666 A1
(43) Pub. Date: Dec. 16, 2004

(54) Method of managing uplink radio resources in CDMA telecommunications system and arrangement therefore

(76) Inventor: Christopher Johnson, Kincardineshire (GB)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/642,497

(22) Filed: Aug. 18, 2003

(30) Foreign Application Priority Data
Jun. 13, 2003 (FI) 20030892

(51) Int. Cl. H04B 7/216

(52) U.S. Cl. 370/335

(57) ABSTRACT

A method and an arrangement for managing uplink radio resources in a CDMA telecommunications systems are provided. The arrangement includes: apparatus for determining an interference level into the primary base transceiver station, apparatus for determining a contribution of secondary cell connections to the interference level; apparatus for computing a proportionality factor for adjusting a reference interference level relative to the interference level, the proportionality factor being proportional to the contribution of the secondary cell connections to the interference level; and apparatus for adjusting the reference interference level relative to the interference level by using the proportionality factor. Embodiments of the invention provide increased accuracy in a radio resource control of a CDMA telecommunications system.

### BACKGROUND OF THE INVENTION

1. Field of the Invention

The present specification relates generally to a method of managing uplink radio resources, typically in a CDMA telecommunications system, and an arrangement for doing the same.

2. Description of the Related Art

A common approach to managing radio resources in CDMA (Code Division Multiple Access) telecommunications systems often includes basing managing decisions upon an interference level experienced by a base transceiver station. The interference level is usually a measurable quantity and may be linked to cell characteristics, such as, but not limited to, cell load and capacity, explicitly by using a characterizing curve, which typically characterizes the relationship between the interference level and the cell characteristic. For example, in the case of the uplink, the characterizing curve is usually a load curve characterizing the relationship between the uplink load and the uplink interference level.

Predictability of the interference level in terms of a change in cell characteristics often plays an important role in managing radio resources in telecommunications systems. It is generally customary to determine an interference level experienced by a base transceiver station by means of a measurement, determine a value of the cell characteristic corresponding to the determined interference level, and predict the change in the interference level that would usually be generated if the cell characteristic were changed. The validity of the resulting decisions made in the radio resource management typically depends upon the accuracy of the interference level determination and/or the predicted change in the interference level.

Predicting changes in the interference level is typically based on knowledge of the characterizing curve. The characterizing curve generally assumes a coupling between the overlapping cells. The coupling generally accounts for the dynamic effect on the interference level that is often due to a series of power adjustment steps in a plurality of user equipment, which effect would typically arise if the transmit power of an individual user equipment were changed.

However, a coupling assumption may break down in some circumstances, and the correspondence between the characteristic curve and the actual relationship between the interference level and the cell characteristic may fail. A failure in the correspondence generally leads to inaccuracy in the interference level prediction, thus often resulting in an erroneous radio resource management.

### SUMMARY OF THE INVENTION

An object of certain embodiments of the present invention is to provide an improved method and/or an arrangement of managing uplink radio resources. According to certain embodiments of the invention, there may be provided a method of managing uplink radio resources in a CDMA telecommunications system including a primary base transceiver station, usually used for providing a primary cell, and at least one secondary base transceiver station, usually used for providing at least one secondary cell. The method typically includes: determining an interference level into the primary base transceiver station; determining a contribution of secondary cell connections to the interference level; computing a proportionality factor, generally used for adjusting a reference interference level relative to the interference level, the proportionality factor commonly being proportional to the contribution of the secondary cell connections to the interference level; and adjusting the reference interference level relative to the interference level, usually by using the proportionality factor.

According to another embodiment of the present invention, there may be provided an arrangement for managing uplink radio resources in a CDMA telecommunications system including a primary base transceiver station often included to provide a primary cell and at least one secondary base transceiver station often included to provide at least one secondary cell. The arrangement typically includes means for determining an interference level into the primary base transceiver station, means for determining a contribution of secondary cell connections to the interference level, means for computing a proportionality factor for adjusting a reference interference level relative to the interference level, the proportionality factor being proportional to the contribution of the secondary cell connections to the interference level, and means for adjusting the reference interference level relative to the interference level by using the proportionality factor. Some preferred embodiments of the invention are described in the dependent claims.

The method and arrangement of certain embodiments of the present invention provide several advantages. In a preferred embodiment of the invention, an uplink radio resource management commonly accounts for a partial coupling between the cells, thus typically resulting in accuracy in the radio resource control.

### BRIEF DESCRIPTION OF THE DRAWINGS

In the following, certain embodiments of the present invention will be described in greater detail with reference to some of the preferred embodiments and the accompanying drawings, in which

FIG. 1 shows an example of the structure of a representative CDMA telecommunications system;

FIG. 2 illustrates commonly monitored effects of cell coupling schemes on power adjustment of user equipment;

FIG. 3 illustrates a typical interference level and a typical reference interference level;

FIG. 4 shows an arrangement according to certain embodiments of the invention; and

FIG. 5 shows an example of the methodology used by the arrangement according to certain embodiments of the invention.

### DETAILED DESCRIPTION OF THE PREFERRED EMBODIMENTS

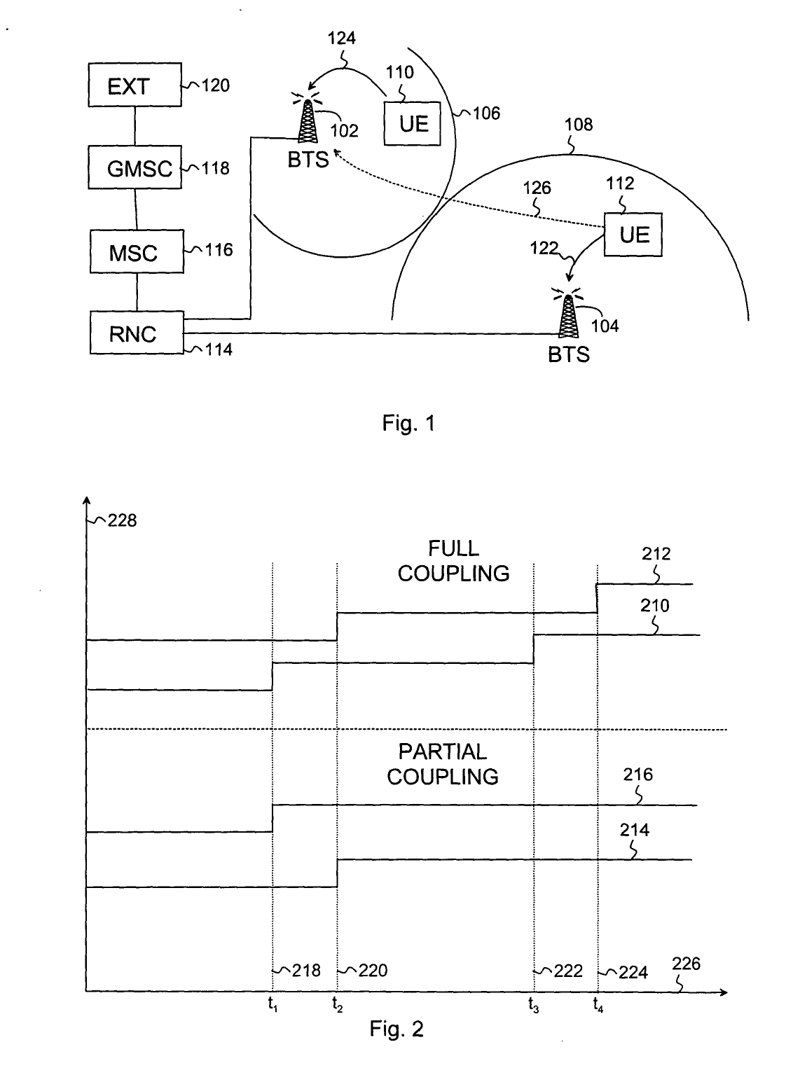

FIG. 1 illustrates an example of a simplified structure of a CDMA (Code Division Multiple Access) telecommunications system to which certain embodiments of the invention may be applied.

The CDMA telecommunications system may be based on, for example, WCDMA (Wideband Code Division Multiple Access) technology that is often utilized in third generation cellular telecommunications systems. The representative structure and function of WCDMA telecommunications systems are known to a person skilled in the art, and only network elements that are generally relevant to embodiments of the invention will be described.

In the representative CDMA telecommunications system, some of the network elements are presented in terms of circuit-switched domain. However, certain embodiments of the invention may be applied to systems, such as, but not limited to, IP-RAN (Internet Protocol Radio Access Network) utilizing packet-switched technology.

FIG. 1 shows a typical primary base transceiver station 102 and a commonly included secondary base transceiver station 104 for providing a representative primary cell 106 and a typical secondary cell 108, respectively, for a representative first user equipment 110 and a commonly included second user equipment 112 that is generally configured to operate in the cellular telecommunications network. In a third generation network, a node B is often equivalent to the base transceiver station 102, 104. Sizes of the primary cell 106 and the secondary cell 108 may generally range from a macro-cell with an operating range on the order of kilometers to a femto-cell with an operating range on the order of tens of centimeters.

In the representative CDMA telecommunications system, the first user equipment commonly communicates by means of a primary cell connection 124 to the primary base transceiver station 102, thus generally contributing to the interference level into the primary base transceiver station 102. The second user equipment typically communicates by means of a secondary cell connection 122 to the secondary base transceiver station 104. A portion 126 of the radio signal associated with the secondary cell connection 122 is usually transferred to the primary base transceiver station 102, thus often contributing to the interference level into the primary base transceiver station 102.

An entity that includes cells of different operating ranges, such as, but not limited to, a macro-cell, a micro-cell, a nano-cell, a pico-cell, and/or a femto-cell, is often called a hierarchical cell structure, wherein the cells of different sizes may have a partial or total overlap with each other.

The representative CDMA telecommunications system may further include a radio network controller 114 (RNC) generally used for controlling the primary and secondary base transceiver stations 102, 104. A base transceiver station 102, 104 and the radio network controller 114 together typically form a radio access network (RAN). The representative base transceiver stations 102, 104 may share a radio network controller 114, and/or the base transceiver stations 102, 104 may be controlled by separate radio network controllers 114 that are commonly capable of transferring information from one to another. The radio network controller 114 usually acts as an interface between higher layers or the CDMA telecommunications system and the radio access network. According to certain embodiments, a radio network controller 114 and a base transceiver station 102, 104 are integrated into a common unit.

The tasks the radio network controller 114 performs include, but are not limited to, power control, handover control, admission control, packet scheduling, code management, and/or load control.

A common task of the admission control is to evaluate whether a capacity request may be granted to the user equipment 110, 112 while satisfying the bearer requirements of the existing connections. An evaluation is generally performed by predicting the load of the cell if the capacity request is admitted.

In packet scheduling, a packet connection that typically includes burst-like traffic is commonly managed. The burst-like traffic may have random characteristics, such as, but not limited to, arrival time, reading time, packet sizes, and/or number of packets per a connection session. These characteristics may often be controlled in a packet scheduling procedure according to an interference level and a reference interference level.

The representative CDMA telecommunication system may further include a mobile switching center (MSC) 116 that is typically connected to the radio network controller 114 usually enabling circuit-switched information transfer between the radio access network and higher layers of the cellular telecommunications system.

The representative CDMA telecommunications system may further include a gateway mobile services switching center 118 (GMSC) that is usually connected to the mobile switching center 116. The gateway mobile services switching center 118 generally attends to the circuit-switched connections that are usually between the core network that typically includes the mobile switching center 116 and/or the gateway mobile services switching 116, and/or external networks (EXT) 120, such as, but not limited to, a public land mobile network (PLMN) and/or a public switched telephone network (PSTN).

The user equipment 110, 112 commonly provides a user with access to the cellular telecommunication system. The user equipment 110, 112 may include conventional components, including, but not limited to, wireless modems, processors with software, memory, a user interface, and/or a display. The user equipment 110, 112 usually performs radio resource management, such as, but not limited to, power control and/or handover control. The structure and functions of the mobile station 110, 112 are known to a person skilled in the art, and thus will not be described in detail.

FIG. 2 illustrates representative imaginary power control sequences of the first user equipment 110 and the second user equipment 112 in two coupling schemes separated by a horizontal dashed line. The upper portion of FIG. 2 illustrates a full coupling scheme between the primary cell 106 and the secondary cell 108. The lower portion of FIG. 2 shows a partial coupling scheme between the primary cell 106 and the secondary cell 108. The full coupling scheme is typical for a non-hierarchical cell structure, wherein power levels 210, 212 of the first user equipment 110 and the second user equipment 112, respectively, are typically approximately of the same order of magnitude. The partial coupling scheme shown in the lower portion of FIG. 2 may preferably be applied to a hierarchical cell structure, wherein the size of the primary cell 106 is generally smaller than that of the secondary cell 108. Such a situation is realized, for example, when the primary cell 106 is a pico-cell, and/or the secondary cell 108 is a macro-cell. The x-axis 226 and y-axis 228 show time and power, respectively, in arbitrary units.

In the initial state of the full coupling scheme, the first user equipment 110 may be camped on the primary cell 106 and the second user equipment 112 may be camped on the secondary cell 108.

At time instant 218 (t₁), the power level 210 of the first user equipment 110 is increased, for example, due to a transition from an idle mode to an active mode.

At time instant 220 (t₂), the power level 212 of the second user equipment 112 is increased, generally so as to compensate for the interference level increase caused by, for example, the increase in the power level 210 of the first user equipment 110, thus generally resulting in an increase in the interference level into the primary base transceiver station 102.

At time instant 222 (t₃), the power level 210 of the first user equipment 110 is increased, often as a result of an interference level increase due to, for example, the increase of the power level 212 of the second user equipment 112 at time instant 220 t₂.

At time instant 224 (t₄), the power level of the second user equipment 112 is increased, typically as a response to an increased interference level due to, for example, an increase in the power level 210 of the first user equipment 110, thus commonly resulting in a further increase in the interference level into the primary base transceiver station 102. The iteration of the imaginary power control steps may be continued with decreasing step size in the power increase.

In the initial state of the partial coupling scheme, the first user equipment 110 may be camped on the primary cell 106 and the second user equipment 112 may be camped on the secondary cell 108.

At time instant 218 (t₁), the power level 216 of the second user equipment 112 is typically increased, for example, due to a transition from an idle mode to an active mode.

At time instant 220 (t₂), the power level 214 of the first user equipment 110 is generally increased in order to compensate for the interference level increase caused by, for example, the increase of the power level 216 of the second user equipment 112 at time instant 218 (t₁). However, due to the generally small transmit power of the first user equipment 110, the resulting increase in the interference level into the secondary base transceiver station 104 is often negligible, and the power level adjustment needed for the second user equipment 112 is typically small. As a result, the feedback chain of successive power adjustments is commonly interrupted, and the power levels 214, 216 of both user equipment 110 and 112 are typically stabilized in the early stage of iteration. The final interference level into the primary base transceiver station 102 is usually affected by the second user equipment 112. However, the effect of the first user equipment 110 on the final interference level into the secondary base transceiver station 104 is generally small. According to certain embodiments, the two cells 106, 108 are deemed to be partially coupled.

Adjustments in the power levels 210, 212, 214, 216 may be based on, for example, uplink link budgets of the user equipment 110, 112. An increase in the interference level usually results in a decrease in the link budget, which is often compensated by increasing the transmitting power level 210, 212, 214, 216.

The example of the imaginary power adjustment chains in the partially coupled scheme shown in FIG. 2 suggests that the interference experienced by the primary base transceiver station 102 may be divided into a cell-load-dependent portion and a cell-load-independent portion. The cell-load independent portion typically arises from the secondary cell connections, in other words, uplink connections of a plurality of second user equipment 112 to the at least one secondary cell 108.

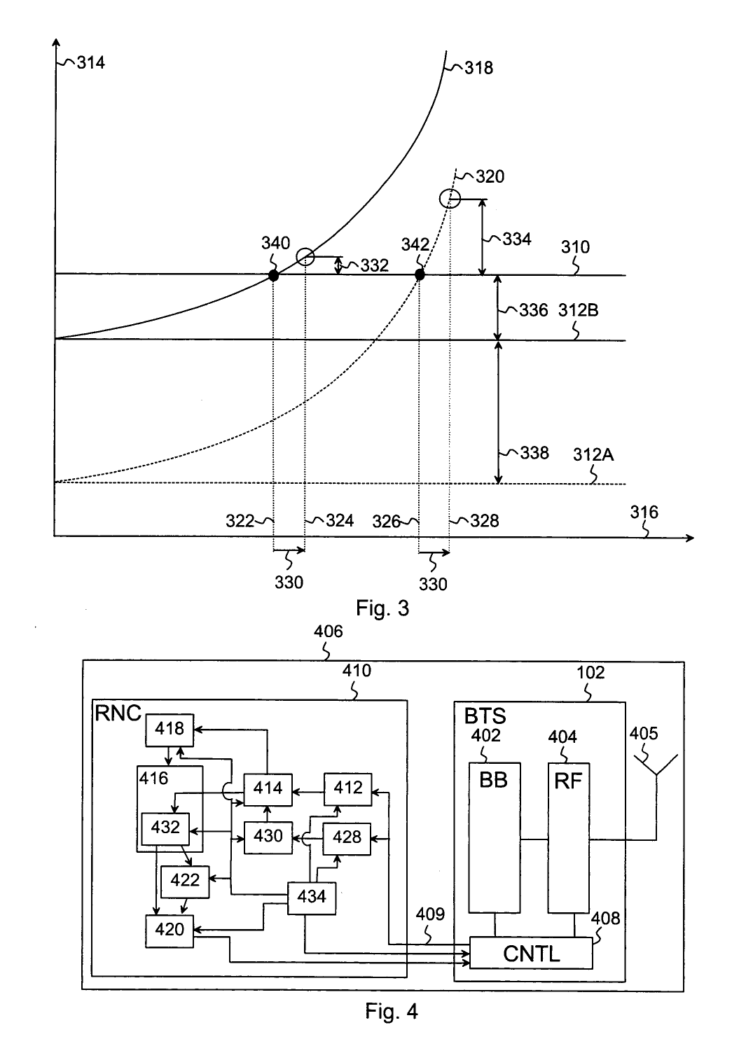

FIG. 3 illustrates a representative interference level 310 into the primary base transceiver station 102 and a representative reference interference level 312B. A priori reference interference level 312A, such as a background noise level, is also shown. The a priori reference interference level 312A may have a predetermined value set by, for example, a network planner. The a priori reference interference level 312A may be tuned using a separate algorithm, typically after the a priori interference level has been initialised by the network planner. The y-axis 314 shows a value of commonly seen interference in an arbitrary unit. The y-axis quantity may also be called, for example, an interference margin, an interference increase, or a noise rise. The x-axis 316 shows a typical cell load in an arbitrary unit. The representative interference level 310 may be expressed by means of formula

I=I_{REF}+I_{PRIM}+I_{SEC}, (1)

where I is generally the interference level 310, I_{REF} is commonly the reference interference level 312B, I_{PRIM} is normally a contribution of the primary cell connections 124 to the interference level 310, and I_{SEC} is typically a contribution of the secondary cell connections 122 to the interference level 310.

FIG. 3 further shows a representative load curve 318 representing an example of a characterising curve, which typically characterizes the relation between the interference level 310 and a cell characteristic, such as, but not limited to, a cell load.

In one representative embodiment, the characterizing curve may be expressed with load curve equation

$$I = 10 \times Log ( \frac{1}{1 - {L}_{UL}} ) + f , \qquad ( 2 )$$

wherein I generally represents a rise in the interference level in arbitrary units, L_{UL} normally represents an uplink cell load as a percentage of a full load, and f is commonly a shift factor representing the coupling between the cells 106, 108.

In one representative embodiment, the uplink cell load L_{UL} may be expressed with load equation

$${L}_{UL} = {\sum }_{k = 1}^{N} {α}_{k} \times \frac{{( {E}_{b} / No )}_{k}}{{PG}_{k}} \times [ 1 + {i}_{c} ] , \qquad ( 3 )$$

wherein αₖ is typically the activity factor of connection k, E_{b} is usually energy per user bit, Noₖ is generally a noise spectral density, PGₖ is normally the processing gain for connection k, i_{c} is typically the intercell interference ratio accounting for cell coupling and N is commonly the number of active connections.

The interference level 310 may be, for example, a total uplink interference power into the primary base transceiver station 102. The reference interference level 312B generally represents an interference level, which is usually independent of the cell load of the primary cell 106.

FIG. 4 shows an example of a primary base transceiver station 102, a network controller 410, and an arrangement 406 for managing uplink radio resources in a CDMA telecommunications system. The exemplary primary base transceiver station 102 typically includes an antenna unit 405 for converting an uplink radio signal 122, 124, 126 into a radio frequency electric signal, which is normally transferred into the radio frequency part 404 (RF). The radio frequency part 404 generally converts the radio frequency electric signal into a base band frequency digital signal, which is usually received by a base band part 402 (BB). The base band part 402 typically performs signal processing on the base band frequency digital signal. For example, power measurements on a received signal 124, 126 and a resulting interference level determination are often carried out in the base band part 402. A control unit 408 normally controls the base band part 402 and/or the radio frequency part 404. According to certain embodiments, the interference level information is usually delivered from the base band part 402 to the control unit 408, which typically signals the interference level information 409 to the radio network controller 410 by using, for example, a separate signaling channel. The interference level information may be reported to the radio network controller 410 periodically, and the period may be adjusted according to a repetition rate of the presented method. A structure and function of a CDMA base transceiver station is known to a person skilled in the art and only relevant parts will be described herein.

The interference level information 409 is generally delivered from the base transceiver station 102 to means 412, which normally determines a contribution of secondary cell connections 122 to the interference level 310. The contribution of the secondary cell connections 122 to the interference level 310 may be obtained from equation (1) by solving I_{SEC}. The means 412, for example, may be located in the radio network controller 114, 410 and is often implemented with a computer and software.

In an embodiment of the invention, the arrangement further includes means 428 for determining a contribution of primary cell connections 124 to the interference level 310 and/or means 430 for determining the contribution of the secondary cell connections 122 to the interference level 310, generally by using the interference level 310 and/or the contribution of the primary cell connections 124 to the interference level 310.

Interference level information 409 is commonly delivered from the base transceiver station 102 to the means 428. The contribution of the primary cell connections 124 to the cell load may be estimated, for example, by using SIR (Signal-to-Interference) targets for the primary cell connections 124, which SIR targets are usually transformed into (E_{b}/No)ₖ figures for each primary cell connection 124. The SIR targets may be delivered to the means 428 using, for example, an outer loop power control. The bit rate of each primary connection 124 is typically known, thus usually enabling the solution of processing gain PGₖ for each primary cell connection k. As a result, a quantity Cₖ=I+(E_{b}/No)ₖ- PGₖ) may be solved, wherein Cₖ generally represents a total received power from a primary cell connection k in logarithm units. The contribution of plurality of the primary cell connections 124 to the interference level 310 may be obtained by summing the Cₖ over the primary cell connections 124. The means 428 may be located in the radio network controller 114, 410 and implemented with a computer and/or software.

The contribution of the secondary cell connections 122 to the interference level 310 may be obtained from equation (1) by solving I_{SEC}=I-I_{REF}-I_{PRIM}. The means 430 may be located in the radio network controller 114, 410 and may be implemented with a computer and/or software.

The typical contribution of the secondary cell connections 122 to the interference level 310 is commonly delivered from means 412, 430 to the means 414, which generally compute a proportionality factor for adjusting the reference interference level 312B relative to the interference level 310. The proportionality factor is normally proportional to the contribution of the secondary cell connections 122 to the interference level 310, which contribution is typically determined by the means 430. The proportionality factor commonly defines a gap 336 between the interference level 310 and the reference interference level 312B. The proportionality factor may also define a gap between the a priori reference interference level 312A, such as, but not limited to, background noise, and the interference level 310, usually provided that the interference level 310 and the a priori reference interference level 312A are represented in the same scale.

In an embodiment of the invention, the arrangement includes means 418 for computing a proportionality factor proportional to a coupling between the primary cell 106 and the at least one secondary cell 108. The proportionality factor P may be expressed as,

P=F*I_{SEC}, (4)

where F is generally a coupling factor representing a coupling between the primary cell 106 and the secondary cell 108. The coupling factor may range, for example, from 0 to 1, where F=0 usually corresponds to a full coupling case, and F=1 a case where there is no coupling between the cells 106, 108. The value of the coupling factor may be fixed to a certain value based on cell measurements. The means 418 may be located in the radio network controller 114, 410 and/or implemented with a computer and/or software.

The proportionality factor and the reference interference level 310 are typically delivered to means 416, which commonly adjust the reference interference level 312B relative to the interference level 310, generally by using the proportionality factor.

In an embodiment of the invention, the arrangement normally includes means 432 for adjusting the reference interference level 312B, usually by shifting the reference interference level 312B relative to the interference level 310 by the amount of the proportionality factor. The shift typically corresponds to the gap 338 between the reference interference level 312B and the a priori reference interference level 312A. According to certain embodiments, the reference interference level 312B may be written as

I_{REF}=I_{AP}+P, (5)

where I_{AP} is commonly the a priori reference interference level 312A and P is usually the proportionality factor, such as that given in Equation (4). The means 418 and 432 may be located in the radio network controller 114, 410 and may be implemented with a computer and/or software.

In an embodiment of the invention, the arrangement includes means 422 for basing a characterizing curve 318, which typically characterizes the relation between a cell characteristic and an interference level 310, usually on the reference interference level 312B. By adjusting the reference interference level 312B, the characterizing curve 318 is normally shifted relative to the interference level 310. As a result, an operating point 340 defined by the characterizing curve 318 and the interference level 310 is generally shifted in x-direction.

The effect of adjusting the reference interference level 312B on the characterizing curve may be expressed in terms of shift factor f given in Equation 2. When relating the reference interference level 312B to the a priori reference interference level 312A, such as, but not limited to, a background noise level, the shift factor typically characterizes the gap 338 between the background noise and the reference interference level 312B. The means 422 may be located in the radio network controller 114, 410 and may be implemented with a computer and/or software.

In an embodiment of the invention, the arrangement includes means 420 for controlling the uplink radio resources that are generally based on the interference level 310 and the reference interference level 312B. The interference level 310 and the reference interference level 312B are usually delivered from the means 416 to means 420. It is also possible that the information on the characterizing curve 318 is delivered from means 422 to means 420, which typically performs the control tasks accordingly.

An example of a control task includes determining an operating point 340 on the characterizing curve 318. Then, a change 330 in load is commonly estimated based on, for example, a change in capacity request. The change 330 in load is usually added to the load 322 corresponding to the operating point 340, thus generally yielding a new load value 324. A change in the interference 332 is normally obtained by means of the new load value 324, and admission control and/or scheduling is typcially performed accordingly.

The usual effect of adjusting the interference level 312B is shown in FIG. 3. The load curve 320 generally corresponds to a situation wherein there is no adjustment of the reference interference level 312B, and the load curve 320 is normally based on the background noise level 312A. This typically corresponds to a full coupling scheme. According to certain embodiments, the cell load 326 that usually corresponds to the operating point 342 is higher, and the change 330 in the cell load and thus a new load value 328 generally lead to a larger change 334 in the interference level than in the partial coupling scheme. The usually larger change 334 in the interference level often results in pessimistic estimation of the interference level and waste of radio resources.

In an embodiment of the invention, the arrangement further includes means 434 for providing time control for the arrangement and/or the method. The time control generally includes a repetition rate and duration of the repetition sequence applied to embodiments of the invention. A repetition rate may be adjusted by the network planner and the method may be repeated, for example, 20 times per second. The duration of the repetition sequence may vary from approximately 100 ms to tens of seconds. The means 434 may be located in the radio network controller 114, 410 and implemented with a computer and/or software.

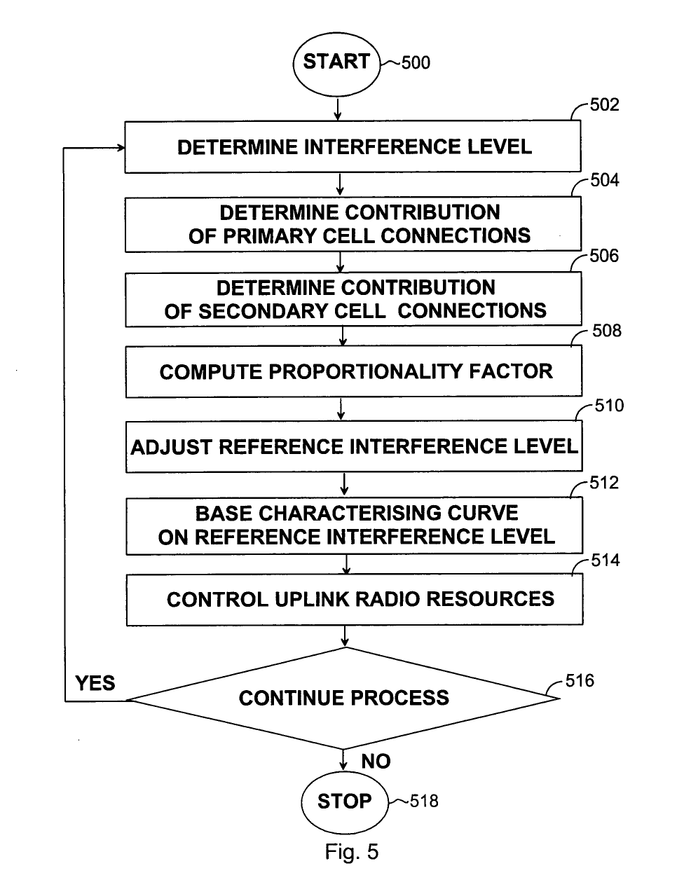

With reference to FIG. 5, the methodology used by the arrangement according to certain embodiments of the invention is shown. In 500, the method typically starts. In 502, the interference level 310 into the primary base transceiver station 102 is usually determined. In 504, a contribution of primary cell connections 124 to the interference level 310 is generally determined. In 506, a contribution of the secondary cell connections 122 to the interference level 310 is commonly determined. In 508, a proportionality factor for adjusting the reference interference level 312 relative to the interference level 310 is typically computed. In 510, the reference interference level 312 relative to the interference level 310 is normally adjusted by using the proportionality factor. In 512, a characterizing curve 318 is usually based on the reference interference level 312. In 514, uplink radio resources are generally controlled based on the interference level 310 and/or the reference interference level 312. In 516, the method is typically repeated. In 518, the method is usually stopped.

Even though the invention is described above with reference to an example according to the accompanying drawings, it is clear that the invention is not restricted thereto but it can be modified in several ways within the scope of the appended claims.

We claim:

1. A method of managing uplink radio resources in a CDMA telecommunications system comprising a primary base transceiver station for providing a primary cell and at least one secondary base transceiver station for providing at least one secondary cell, the method comprising:
determining an interference level into the primary base transceiver station;
determining a contribution of secondary cell connections to the interference level;
computing a proportionality factor for adjusting a reference interference level relative to the interference level, the proportionality factor being proportional to the contribution of the secondary cell connections to the interference level; and
adjusting the reference interference level relative to the interference level by using the proportionality factor.

2. The method of claim 1, further including computing a proportionality factor proportional to a coupling between the primary cell and the at least one secondary cell.

3. The method of claim 1, further including controlling the uplink radio resources based on the interference level and the reference interference level.

4. The method of claim 1, further including basing a characterizing curve, which characterizes relation between a cell characteristic and an interference level, on the reference interference level.

5. The method of claim 1, further including determining a contribution of primary cell connections to the interference level; and
determining the contribution of the secondary cell connections to the interference level by using the interference level and the contribution of the primary cell connections to the interference level.

6. The method of claim 1, further including adjusting the reference interference level by shifting the reference interference level relative to the interference level by the amount of the proportionality factor.

7. The method of claim 1, further including repeating the method for a predetermined period of time.

8. The method of claim 1, further including repeating the method at a predetermined rate.

9. An arrangement for managing uplink radio resources in a CDMA telecommunications system comprising a primary base transceiver station for providing a primary cell and at least one secondary base transceiver station for providing at least one secondary cell, the arrangement comprising:
first determining means for determining an interference level into the primary base transceiver station;
second determining means for determining a contribution of secondary cell connections to the interference level;
first computing means for computing a proportionality factor for adjusting a reference interference level relative to the interference level, the proportionality factor being proportional to the contribution of the secondary cell connections to the interference level; and
first adjusting means for adjusting the reference interference level relative to the interference level by using the proportionality factor.

10. The arrangement of claim 9, further including second computing means for computing a proportionality factor proportional to a coupling between the primary cell and the at least one secondary cell.

11. The arrangement of claim 9, further including controlling means for controlling the uplink radio resources based on the interference level and the reference interference level.

12. The arrangement of claim 9, further including basing means for basing a characterizing curve, which characterizes relation between a cell characteristic and an interference level, on the reference interference level.

13. The arrangement of claim 9, further including:
third determining means for determining a contribution of primary cell connections to the interference level; and
fourth determining means for determining the contribution of the secondary cell connections to the interference level by using the interference level and the contribution of the primary cell connections to the interference level.

14. The arrangement of claim 9, further including second adjusting means for adjusting the reference interference level by shifting the reference interference level relative to the interference level by the amount of the proportionality factor.

15. The arrangement of claim 9, further including providing means for providing time control for the arrangement.

16. An arrangement for managing uplink radio resources in a CDMA telecommunications system comprising a primary base transceiver station for providing a primary cell and at least one secondary base transceiver station for providing at least one secondary cell, the arrangement comprising:
a first sensor for determining an interference level into the primary base transceiver station;
a second sensor for determining means for determining a contribution of secondary cell connections to the interference level;
a first processor for computing a proportionality factor for adjusting a reference interference level relative to the interference level, the proportionality factor being proportional to the contribution of the secondary cell connections to the interference level; and
a first tuner for adjusting the reference interference level relative to the interference level by using the proportionality factor.
